(19) United States
(12) Patent Application Publication
(10) Pub. No.: US 2014/0307005 A1
(43) Pub. Date: Oct. 16, 2014

(54) IMAGE DISPLAY APPARATUS AND IMAGE DISPLAY METHOD

(71) Applicant: Sony Corporation, Tokyo (JP)

(72) Inventor: Koji Kita, Kanagawa (JP)

(73) Assignee: Sony Corporation, Tokyo (JP)

(21) Appl. No.: 14/221,311

(22) Filed: Mar. 21, 2014

(30) Foreign Application Priority Data
Apr. 10, 2013 (JP) 2013-082057

(51) Int. Cl. G02F 1/1335; G02B 27/22; G09G 3/36; G02B 27/28

(52) U.S. Cl. CPC G02F 1/1336; G02B 27/283; G02B 27/2235; G09G 3/36
USPC 345/690; 349/9; 345/87

(57) ABSTRACT

An image display apparatus includes a light source unit including a laser light source, at least one reflection-type light modulation element configured to modulate light to be incident thereon and reflect the modulated light, an optical system that includes an optical element configured to cause light from the light source unit to be incident on the at least one reflection-type light modulation element, and to transmit light modulated by the at least one reflection-type light modulation element therethrough, and is configured to emit the modulated light transmitted through the optical element to a projection optical system capable of projecting light, and at least one polarizing plate that is arranged in the optical system, is configured to control a polarizing direction of the modulated light transmitted through the optical element, and has an extinction ratio of equal to or less than 50:1.

### CROSS REFERENCE TO RELATED APPLICATIONS

This application claims the benefit of Japanese Priority Patent Application JP 2013-082057 filed Apr. 10, 2013, the entire contents of which are incorporated herein by reference.

### BACKGROUND

The present disclosure relates to an image display apparatus such as a projector and to an image display method.

An image display apparatus such as a projector has been known in the past. For example, light from a light source is modulated by a light modulation element such as a liquid crystal element and the modulated light is projected on a screen or the like, thereby displaying an image. As the light modulation element, a reflection-type liquid crystal display element, a transmission-type liquid crystal element, a DMD (Digital Micromirror Device), or the like is used.

In recent years, a projector that uses a laser light source as a light source has been developed. Japanese Patent Application Laid-open No. 2013-015762 describes a configuration of an image display apparatus that modulates light from a laser light source by a reflection-type light modulation element (see, for example, FIG. 1 thereof). Japanese Patent Application Laid-open No. 2013-015762 describes techniques related to an illumination optical system of such a projector.

### SUMMARY

An image display apparatus with high performance that uses the laser light source and the reflection-type light modulation element described above is expected to be developed.

In view of the circumstances as described above, it is desirable to provide an image display apparatus with high performance that uses a laser light source and a reflection-type light modulation element and an image display method.

According to an embodiment of the present disclosure, there is provided an image display apparatus including a light source unit, at least one reflection-type light modulation element, an optical system, and at least one polarizing plate.

The light source unit includes a laser light source.

The at least one reflection-type light modulation element is configured to modulate light to be incident thereon and reflect the modulated light.

The optical system includes an optical element configured to cause light from the light source unit to be incident on the at least one reflection-type light modulation element, and to transmit light modulated by the at least one reflection-type light modulation element therethrough, and is configured to emit the modulated light transmitted through the optical element to a projection optical system capable of projecting light.

The at least one polarizing plate is arranged in the optical system, is configured to control a polarizing direction of the modulated light transmitted through the optical element, and has an extinction ratio of equal to or less than 50:1.

In the image display apparatus, the at least one polarizing plate that is arranged in the optical system and has an extinction ratio of equal to or less than 50:1 controls the polarizing direction of the modulated light transmitted through the optical element. Accordingly, it is possible to increase the degree of polarization of modulated light while preventing a polarizing plate from being deteriorated due to light absorption. As a result, it is possible to realize an image display apparatus with high performance that uses a laser light source and a reflection-type light modulation element.

The at least one polarizing plate may have an extinction ratio of equal to or less than 10:1.

Accordingly, it is possible to sufficiently preventing the polarizing plate from being thermally deteriorated.

The at least one reflection-type light modulation element may include three reflection-type light modulation elements that modulate red light, green light, and blue light. In this case, the optical element may be arranged as three optical elements configured to cause the light of the colors to be incident on the three reflection-type light modulation elements, and to transmit modulated red light, modulated green light, and modulated blue light therethrough. Moreover, the optical system may include a combining element configured to combine the modulated light of the colors transmitted through the three optical elements and to emit the combined light to the projection optical system. Moreover, the at least one polarizing plate may include at least one of: three polarizing plates for the modulated light of the colors arranged between the three optical elements; and the combining element and a polarizing plate for the combined light emitted from the combining element.

In the image display apparatus, at least any one of the three polarizing plates for the modulated light of the colors and the polarizing plate for the combined light is arranged. Accordingly, it is possible to display a color image with high precision with a simple design.

The at least one polarizing plate may include the three polarizing plates for the modulated light of the colors and the polarizing plate for the combined light.

In the image display apparatus, the three polarizing plates for the modulated light of the colors and the polarizing plate for the combined light are arranged. Accordingly, it is possible to display a color image with high precision.

The three polarizing plates may each include a narrow-band polarizing plate having a respective wavelength band of the light of the colors. In this case, the polarizing plate for the combined light may include a wide-band polarizing plate having a visible wavelength hand of the combined light.

As described above, by using a polarizing plate having a wavelength band of light to be incident thereon, it is possible to increase the degree of polarization of modulated light (combined light) while sufficiently preventing heat from generating.

The light source unit, the at least one reflection-type light modulation element, the optical system, and the at least one polarizing plate may be used as a set to display a right eye image and a left eye image for three-dimensional display.

Accordingly, it is possible to sufficiently prevent crosstalk from occurring and to display a three-dimensional image with high precision.

The right eye image may be displayed by light having a first polarizing direction, and the left eye image may be displayed by light having a second polarizing direction perpendicular to the first polarizing direction.

As described above, the right eye image and the left eye image may be displayed by light whose polarizing directions are perpendicular to each other. Because the degree of polarization of modulated light (combined light) in each image can be increased, it is possible to sufficiently prevent crosstalk from occurring.

According to an embodiment of the present disclosure, there is provided an image display method including emitting light by a light source unit including a laser light source.

Light from the light source unit is caused to be incident on a reflection-type light modulation element by an optical element, and light modulated by the reflection-type light modulation element is transmitted through the optical element.

By at least one polarizing plate that has an extinction ratio of equal to or less than 50:1, a polarizing direction of the modulated light transmitted through the optical element is controlled and the modulated light is emitted to a projection optical system capable of projecting light, thereby displaying an image.

As described above, according to the present disclosure, it is possible to provide an image display apparatus with high performance that uses a laser light source and a reflection-type light modulation element and an image display method.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram showing a configuration of an image display apparatus according an embodiment of the present disclosure;

FIG. 2 is a schematic diagram showing a configuration of a first image display unit shown in FIG. 1;

FIG. 3 is a schematic diagram showing a configuration of a second image display unit shown in FIG. 1;

FIG. 4 is a table showing relationships between the extinction ratio of a polarizing plate, the transmittance, and the temperature;

FIG. 5 is a graph showing a relationship between the extinction ratio and the transmittance;

FIGS. 6A-6B are schematic diagrams showing arrangement examples of first and second polarizing plates; and

FIG. 7 is a schematic diagram showing a configuration of an image display apparatus according to another embodiment of the present disclosure.

### DETAILED DESCRIPTION OF EMBODIMENTS

Hereinafter, an embodiment of the present disclosure will be described with reference to the drawings.

### (Configuration of Image Display Apparatus)

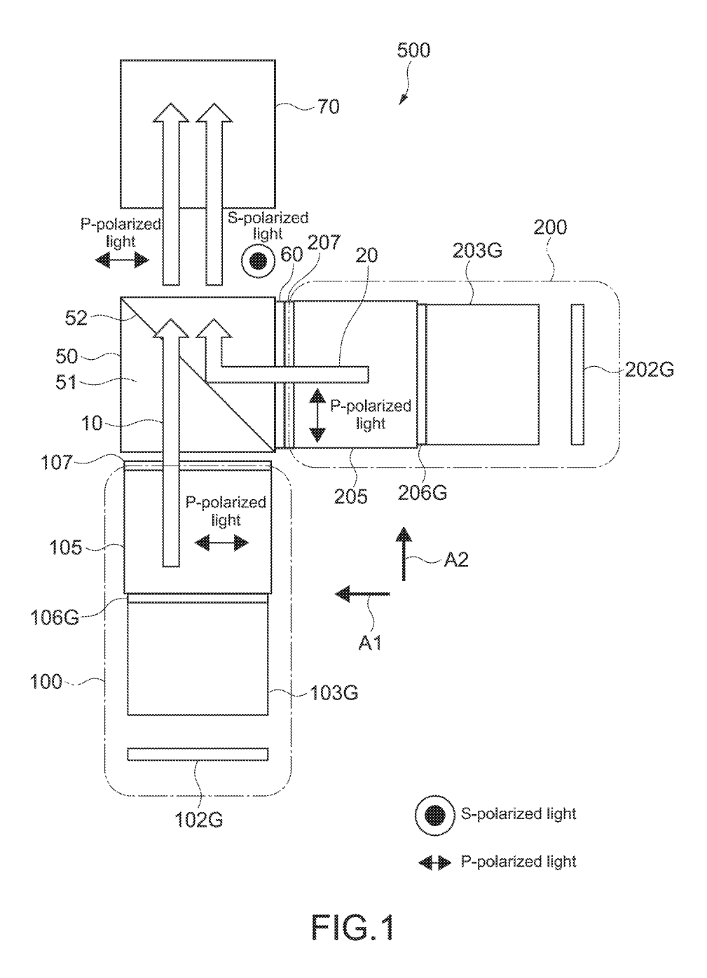

FIG. 1 is a schematic diagram showing a configuration of an image display apparatus according an embodiment of the present disclosure. An image display apparatus 500 is a projector for cinema that uses a laser light source, and is capable of displaying a three-dimensional (stereoscopic) image using polarizing characteristics of light.

The image display apparatus 500 includes a first image display unit 100 that displays a right eye image 10 and a second image display unit 200 that displays a left eye image 20 for three-dimensional display, and an image combining unit 50 that combines the right eye image 10 and the left eye image 20 and emits the image light. Moreover, the image display apparatus 500 includes a wide-band ½ wavelength plate 60 having a wide wavelength band of light and a projection optical system 70 that is capable of projecting an image on a screen or the like. The wide-band ½ wavelength plate 60 is arranged between the second image display unit 200 and the image combining unit 50. The projection optical system 70 is arranged on an emission side of the image combining unit 50, and projects the image light of the right eye image 10 and the left eye image 20 emitted from the image combining unit 50.

The first and second image display units 100 and 200 modulate red light, green light, and blue light (light of the RGB colors), and combines the modulated light (images) of the colors, thereby displaying a color image. The first and second image display units 100 and 200 can be used separately as the image display apparatus according to the embodiment of the present disclosure. Specifically, in the image display apparatus 500 according to the embodiment of the present disclosure, the respective image display apparatuses using an embodiment of the present disclosure are used to display the right eye image 10 and the left eye image 20.

The image combining unit 50 is a prism-type beam splitter. The image combining unit 50 has characteristics of a polarizing beam splitter having a high reflectance of s-polarized light and a high transmittance of p-polarized light over all wavelength bands of three primary colors of light to be used. In this embodiment, two isosceles right prisms 51 having about the same shape are joined to each other, and a polarizing film having predetermined optical characteristics is formed on a junction surface 52. The junction surface 52 is disposed at an angle of 45 degrees with respect to the traveling direction of the light from the right eye image 10 and the traveling direction of the light from the left eye image 20, and the s-polarized light and the p-polarized light are defined with respect to the junction surface 52. The s-polarized light is reflected on the junction surface 52 and the p-polarized light is transmitted through the junction surface 52. As the image combining unit 50, an analyzer having another configuration such as a wire grid may be used.

The wide-band ½ wavelength plate 60 has a function to rotate the polarizing direction by 90 degrees over all wavelength bands of three primary colors of light to be used The projection optical system 70 includes, for example, a projection lens that enlarges modulated light at a predetermined magnification and projects an image on a screen. The configurations of the wide-band ½ wavelength plate 60 and the projection optical system 70 are not limited and may be set appropriately.

The first and second image display units 100 and 200 according to this embodiment each have a configuration in which the right eye image 10 and the left eye image 20 can be generated by the p-polarized light, and the images can be displayed. The image light of the right eye image 10 emitted from the first image display unit 100 enters the image combining unit 50 as the p-polarized light, is transmitted through the junction surface 52, and is emitted to the projection optical system 70. The polarizing direction of the image light of the left eye image 20 emitted from the second image display unit 200 is rotated by 90 degrees by the wide-band ½ wavelength plate 60. Therefore, the image light of the left eye image 20 enters the image combining unit 50 as the s-polarizing light, is reflected on the junction surface 52, and is emitted to the projection optical system 70.

Therefore, in this embodiment, a right eye image is displayed by the p-polarized light with respect to the junction surface 52 and a left eye image is displayed by the s-polarized light with respect to the junction surface 52. Here, the p-polarized light with respect to the junction surface 52 corresponds to light in the first polarizing direction in this embodiment, and the s-polarized light corresponds to light in the second polarizing direction perpendicular to the first polarizing direction. As will be described later, the first and second image display units 100 and 200 are capable of generating the right eye image 10 and the left eye image 20 with a high degree of polarization. Therefore, it is possible to sufficiently prevent crosstalk between the right eye image 10 and the left eye image 20 from occurring.

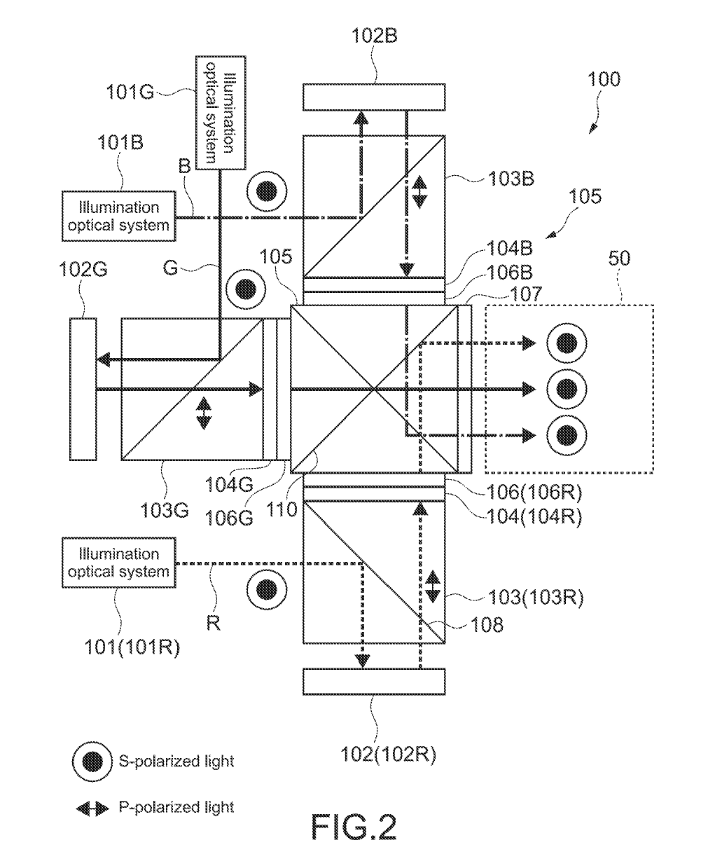

FIG. 2 is a schematic diagram showing a configuration of the first image display unit 100. FIG. 2 shows the first image display unit 100 viewed from the direction of an arrow A1 shown in FIG. 1. It should be noted that in FIG. 1, a light modulation element 102G, a polarizing element 103G, a color combining prism 105, a first polarizing plate 106G, and a second polarizing plate 107 in the first image display unit 100 are shown, and illustration of another configuration is omitted.

The first image display unit 100 includes illumination optical systems 101, reflection-type light modulation elements 102 (hereinafter, referred to as the light modulation element 102), reflection-type polarizing elements 103 (hereinafter, referred to as the polarizing element 103), ½ wavelength plates 104, and the color combining prism 105. Moreover, the first image display unit 100 includes first polarizing plates 106 disposed between the polarizing elements 103 and the color combining prism 105, and the second polarizing plate 107 disposed between the color combining prism 105 and the image combining unit 50. The number of the illumination optical systems 101, the light modulation elements 102, the polarizing elements 103, the ½ wavelength plates 104, and the first polarizing plates 106 is 3, and these are provided for light of the RGB colors.

The illumination optical system 101 includes a light source unit (not shown) configured to emit laser light of the RGB colors. The light source unit includes at least one laser light source configured to emit laser light of the colors. An illumination optical system 101R includes a light source unit configured to emit red laser light R, and an illumination optical system 101G includes a light source unit configured to emit green laser light G. Moreover, an illumination optical system 101B includes a light source unit configured to emit blue laser light B. The illumination optical system 101 further includes an integrator optical system (not shown) configured to emit laser light from a light source unit to the light modulation element 102 with a uniform illuminance distribution. The integrator optical system includes, for example, a fly-eye lens, a condenser lens, or a field lens.

The configuration of the illumination optical system 101 is not limited.

The light modulation element 102 is a reflection-type light modulation element, polarization-modulates laser light to be incident thereon based on an image signal corresponding to light of the respective colors supplied from the outside, and reflects the laser light. As the light modulation element 102, a reflection-type liquid crystal element is typically used, but it is not limited thereto.

The polarizing element 103 is a prism-type beam splitter. The polarizing element 103 has characteristics of a polarizing beam splitter having a high reflectance of s-polarized light and a high transmittance of p-polarized light over all wavelength bands of three primary colors of light or the wavelength band of laser light to be incident thereon. Here, the s-polarized light and the p-polarized light are defined with respect to a junction surface 110 of the color combining prism 105 disposed at an angle of 45 degrees with respect to the laser light of the colors. Then, the s-polarized light is reflected on a junction surface 108 of the polarizing element 103, and the p-polarized light is transmitted through the junction surface 108. As the polarizing element 103, an optical member having another configuration may be used.

The polarizing element 103 corresponds to an optical element that causes light from a light source unit to be incident on the light modulation element 102, and transmits the light modulated by the light modulation element 102 therethrough. Polarizing element 103R, 103G, and 103B disposed for the light of RGB colors are disposed as three optical element that cause light R, G, and B of the colors to be incident on three light modulation elements 102R, 102G, and 102B, and transmit the modulated red light R, green modulated light G, and blue modulated light B therethrough, respectively.

It should be noted that in this embodiment, the film surface formed on the junction surface 52 of the image combining unit 50 shown in FIG. 1 and the film surface formed on the junction surface 110 of the color combining prism 105 shown in FIG. 2 are twisted with each other. Therefore, the polarizing directions of the s-polarized light and the p-polarized light defined with respect to the junction surface 52 are perpendicular to the polarizing directions of the s-polarized light and the p-polarized light defined with respect to the junction surface 110. Specifically, the s-polarized light and the p-polarized light with respect to the junction surface 110 of the combining prism 105 shown in FIG. 2 are p-polarized light and s-polarized light with respect to the junction surface 52 of the image combining unit 50 shown in FIG. 1, respectively. However, the present disclosure is not limited to such setting.

The color combining prism 105 transmits incident light having a green wavelength band (green laser light G) in the direction of the image combining unit 50, and reflects incident light having a red wavelength band and a blue wavelength band (red laser light R and blue laser light B) in the direction of the image combining unit 50. The color combining prism 105 is configured by joining a plurality of glass prisms (four isosceles right prisms having about the same shape) to each other. On the junction surface 110 of each glass prism, two interference films having predetermined optical characteristics are formed. Of the two interference films, a first interference film reflects the blue laser light B and transmits the red laser light R and the green laser light G therethrough, and a second interference film reflects the red laser light R and transmits the blue laser light B and the green laser light G therethrough.

The color combining prism 105 corresponds to a combining element that combines the modulated light R, G, and B of the colors transmitted through the three polarizing element 103R, 103G, and 103B, and emits the combined light to the projection optical system 70. In this embodiment, the combined light is emitted to the image combining unit 50 disposed in front of the projection optical system 70 to display a three-dimensional image. In this embodiment, an optical system 150 including the three polarizing elements 103R, 103G, and 103B and the color combining prism 105 corresponds to an optical system that emits modulated light transmitted through the polarizing element 103 to the projection optical system 70 capable of projecting light.

The ½ wavelength plate 104 has a function to rotate the polarizing direction by 90 degrees over the wavelength band of laser light to be incident thereon. By using ½ wavelength plates 104R, 104G, and 104B that are optimized for the wavelength bands of laser light of the colors, it is possible to rotate the polarizing direction without decreasing the degree of polarization of light. It should be noted that as the ½ wavelength plates 104R, 104G, and 104B, a wide band ½ wavelength plate may be used.

The three first polarizing plates 106 are disposed for modulated light of the colors between the three polarizing element 103R, 103G, and 103B and the color combining prism 105. In this embodiment, the first polarizing plate 106 is provided behind the ½ wavelength plate 104. However, the first polarizing plate 106 may be disposed in front of the ½ wavelength plate 104. In this case, the direction of the transmission axis of the first polarizing plate 106 is changed appropriately.

The three first polarizing plates 106R, 106G, and 106B are narrow-band polarizing plates having wavelength bands of the laser light of the colors. The narrow-band polarizing plate is a polarizing plate optimized for the wavelength band in a predetermined range out of all wavelength bands of three primary colors of light. The first polarizing plate 106R is optimized for the wavelength band of the red laser light R, and the first polarizing plate 106G is optimized for the wavelength band of the green laser light G. Moreover, the first polarizing plate 106B is optimized for the wavelength band of the blue laser light B. The first polarizing plates 106R, 106G, and 106B control the polarizing directions of the modulated light R, G, and B transmitted through the polarizing elements 103R, 103G, and 103B, respectively. Accordingly, it is possible to increase the degree of polarization of the modulated light R, G, and B to be incident on the color combining prism 105.

The second polarizing plate 107 is disposed as a polarizing plate for the combined light of the modulated light R, G, and B emitted from the color combining prism 105. The second polarizing plate 107 is a wide-band polarizing plate having a visible wavelength band of the combined light of the modulated light R, G, and B. The wide-band polarizing plate is a polarizing plate that is capable of controlling the polarizing direction over all wavelength bands of three primary colors of light. By disposing the second polarizing plate 107 on an emission side of the color combining prism 105, it is possible to increase the degree of polarization of the combined light. It should be noted that the wide-band polarizing plate may be used as the first polarizing plate 106 described above.

The first and second polarizing plates 106 and 107 each have an extinction ratio of equal to or less than 50:1.

Here, the extinction ratio is defined as follows. (Extinction ratio)=(polarizing light transmittance of direction of transmission axis of polarizing plate):(polarizing light transmittance of direction of absorption axis of polarizing plate)

In this embodiment, the three first polarizing plates 106R, 106G, and 106B and the second polarizing plate 107 each have an extinction ratio of equal to or less than 10:1.

However, any polarizing plate may be used as the first and second polarizing plates 106 and 107 as long as it has an extinction ratio of equal to or less than 50:1. As the first polarizing plate 106, a polarizing plate having a smaller extinction ratio than the second polarizing plate 107 may be used and vice versa. As the three first polarizing plates 106R, 106G, and 106B, three polarizing plate having different extinction ratios may be used. It should be noted that the specific configuration of the polarizing plate is not limited, and any configuration may be adopted as long as it has an extinction ratio of equal to or less than 50:1.

In this embodiment, the first polarizing plate 106 and the second polarizing plate 107 correspond to the at least one polarizing plate that is arranged in the optical system 150, is configured to control a polarizing direction of the modulated light transmitted through the polarizing element 103, and has an extinction ratio of equal to or less than 50:1. As described above, in this embodiment, a polarizing plate that has an extinction ratio of equal to or less than 50:1 and reduced so-called polarizing characteristics is used as the polarizing plate that controls the polarizing directions of the modulated light of the colors and the combined light of the RGB colors. Accordingly, it is possible to increase the degree of polarization of modulated light while preventing a polarizing plate from being deteriorated due to light absorption. As a result, it is possible to sufficiently prevent the crosstalk between the right eye image 10 and the left eye image 20 from occurring.

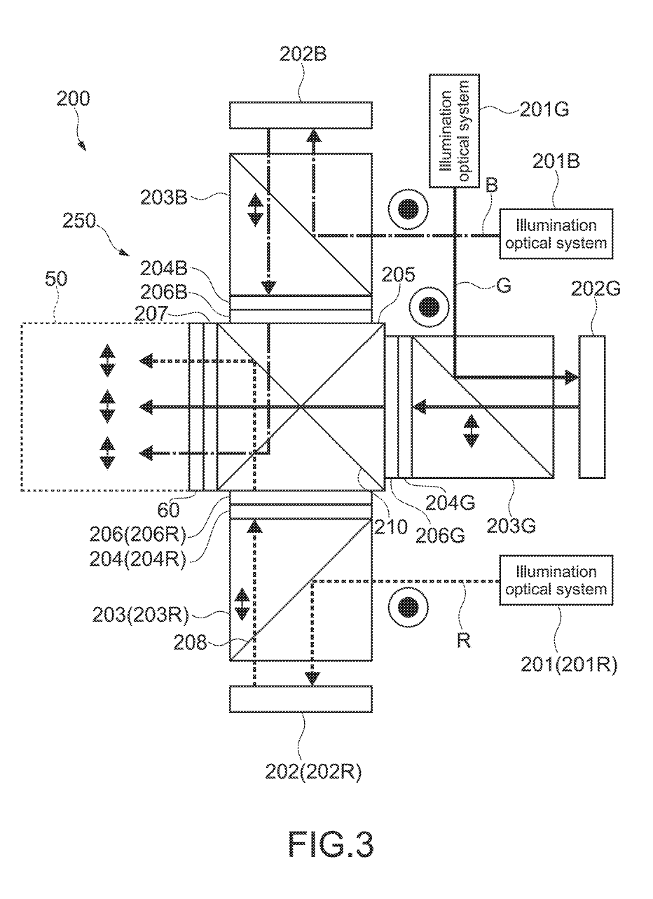

FIG. 3 is a schematic diagram showing the configuration of the second image display unit 200. FIG. 3 shows the second image display unit 200 viewed from the direction of an arrow A2 shown in FIG. 1. It should be noted that in FIG. 1, a light modulation element 202G, a polarizing element 203G, a color combining prism 205, a first polarizing plate 206G, and a second polarizing plate 207 in the second image display unit 200 are shown, and illustration of another configuration is omitted.

The second image display unit 200 has about the same configuration as the first image display unit 100. Specifically, the second image display unit 200 includes illumination optical systems 201, reflection-type light modulation elements 202 (hereinafter, referred to as the light modulation element 202), reflection-type polarizing elements 203 (hereinafter, referred to as the polarizing element 203), ½ wavelength plates 204, and the color combining prism 205. The second image display unit 200 further includes first polarizing plates 206 disposed between the polarizing elements 203 and the color combining prism 205, and the second polarizing plate 207 disposed between the color combining prism 205 and the image combining unit 50. The number of the illumination optical systems 201, the light modulation elements 202, the polarizing elements 203, the ½ wavelength plates 204, and the first polarizing plates 206 is 3, and these are provided for the light of the RGB colors. As described above, the wide-band ½ wavelength plate 60 is disposed between the second polarizing plate 207 of the second image display unit 200 and the image combining unit 50.

In this embodiment, an optical system 250 including three polarizing elements 203R, 203G, and 203B and the color combining prism 205 corresponds to the optical system that emits modulated light transmitted through the polarizing element 203 to the projection optical system 70 that is capable of projecting light. Moreover, the polarizing element 203 has a junction surface 208, and the color combining prism 205 has a junction surface 210.

### (Operation of Image Display Apparatus)

As the operation of the image display apparatus 500, emission of the right eye image 10 by the first image display unit 100 will be mainly described.

From the illumination optical system 101R, the red laser light R of the s-polarized light is emitted. It should be noted that the method of controlling the polarizing direction of the laser light is not limited. The red laser light R of the s-polarized light is reflected on the junction surface 108 of the polarizing element 103R and enters the light modulation element 102R. The modulated red light R modulated by the light modulation element 102R based on an image signal returns to the polarizing element 103R, and the p-polarized light component thereof is transmitted through the junction surface 108. The ½ wavelength plate 104R rotates the polarizing direction of the transmitted modulated red light R of the p-polarized light by 90 degrees. Therefore, the modulated red light R enters the first polarizing plate 106R as the s-polarized light.

In this embodiment, the direction of the transmission axis of the first polarizing plate 106R is aligned with the polarizing direction of the s-polarized light. Therefore, the first polarizing plate 106R transmits the s-polarized light therethrough and absorbs the p-polarized light in the range of the extinction ratio of equal to or less than 10:1.

As a result, the unnecessary component light of the modulated red light R is cut and the degree of polarization of the modulated red light R of the s-polarized light is increased. The modulated red light R of the s-polarized light transmitted through the first polarizing plate 106R enters the color combining prism 105.

Also the green laser light G and the blue laser light B are emitted from the illumination optical systems 101G and 101B as the s-polarized light similarly to the red laser light R described above, and are reflected from the polarizing elements 103G and 103B to the light modulation elements 102G and 102B, respectively. The green modulated light G and the blue modulated light B enter the first polarizing plates 106G and 106B as the s-polarized light by the ½ wavelength plates 104G and 104B, respectively. Then, the first polarizing plates 106G and 106B cut unnecessary component light, thereby increasing the degree of polarization. The green modulated light G and the blue modulated light B transmitted through the first polarizing plates 106G and 106B enter the color combining prism 105.

In the color combining prism 105, the modulated red light R and the blue modulated light B are reflected to the image combining unit 50 by the junction surface 110. The green modulated light G is transmitted though the junction surface 110 and travels to the image combining unit 50. In this way, the modulated red light R, the green modulated light G, and the blue modulated light B are combined and the combined light is emitted to the second polarizing plate 107.

Also the direction of the transmission axis of the second polarizing plate 107 is aligned with the polarizing direction of the s-polarized light. Therefore, also the second polarizing plate 107 transmits the s-polarized light therethrough and absorbs the p-polarized light in the range of the extinction ratio of equal to or less than 10:1. As a result, the unnecessary component light of the combined light is cut and the degree of polarization of the combined light of the s-polarized light is increased. As shown in FIG. 2, the combined light (the modulated light RGB of the colors) transmitted through the second polarizing plate 107 is emitted to the image combining unit 50 as the s-polarized light. As shown in FIG. 1, the combined light enters the image combining unit 50 as the p-polarized light with respect to the junction surface 52 of the image combining unit 50. In this way, the right eye image 10 is generated and the image light thereof is emitted to the image combining unit 50.

Generation and emission of the left eye image 20 by the second image display unit 200 is performed in the same way. The polarizing direction of the combined light emitted as the s-polarized light is rotated by the wide-band ½ wavelength plate 60, and enters the image combining unit 50 as the p-polarized light. As a result, the left eye image 20 enters the junction surface 52 of the image combining unit 50 as the s-polarized light. The right eye image 10 and the left eye image 20 are combined by the image combining unit 50, and the combined image is projected on a screen or the like by the projection optical system 70. For example, by watching the combined image thus projected with glasses having a polarized light filter that transmits the p-polarized light therethrough for the right eye and a polarized light filter that transmits s-polarized light therethrough for the left eye, a viewer can enjoy the three-dimensional image.

As described above, in the image display apparatus 500, the first and second polarizing plates 106 (206) and 107 (207) that are disposed in the optical system 150 (250) and have an extinction ratio of equal to or less than 50:1 control the polarizing directions of modulated light of the colors transmitted through the polarizing element 103 (203), and the unnecessary component light in the polarizing direction is cut. For example, the polarization of the modulated light from the light modulation element 102 (202) is often disturbed when transmitting through the polarizing element 103 (203), the color combining prism 105 (205), other glass, the phase difference element, or the like in the optical path. Even in such a case, the first and second polarizing plates 106 (206) and 107 (207) control the polarizing direction of the modulated light (combined light) appropriately. Accordingly, it is possible to increase the degree of polarization of modulated light of the colors and the combined light of the RGB colors while preventing the first and second polarizing plates 106 (206) and 107 (207) from being thermally deteriorated due to light absorption. Specifically, it is possible to reduce the crosstalk between the right and left images for three-dimensional display and to achieve high contrast while ensuring the reliability of the first and second polarizing plates 106 (206) and 107 (207) with respect to high energy.

As a result, it is possible to realize an image display apparatus with high performance that uses a laser light source and a reflection-type light modulation element.

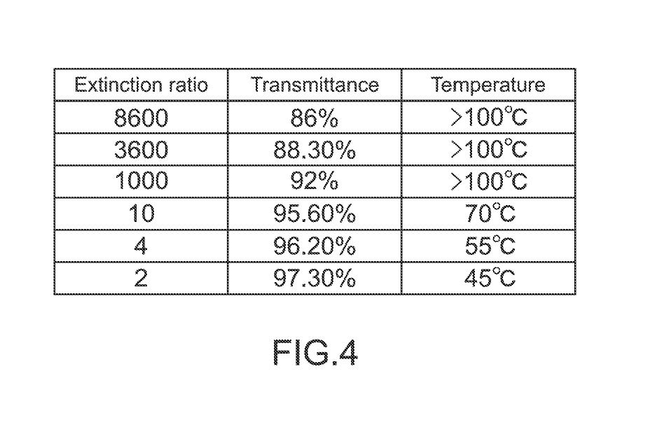

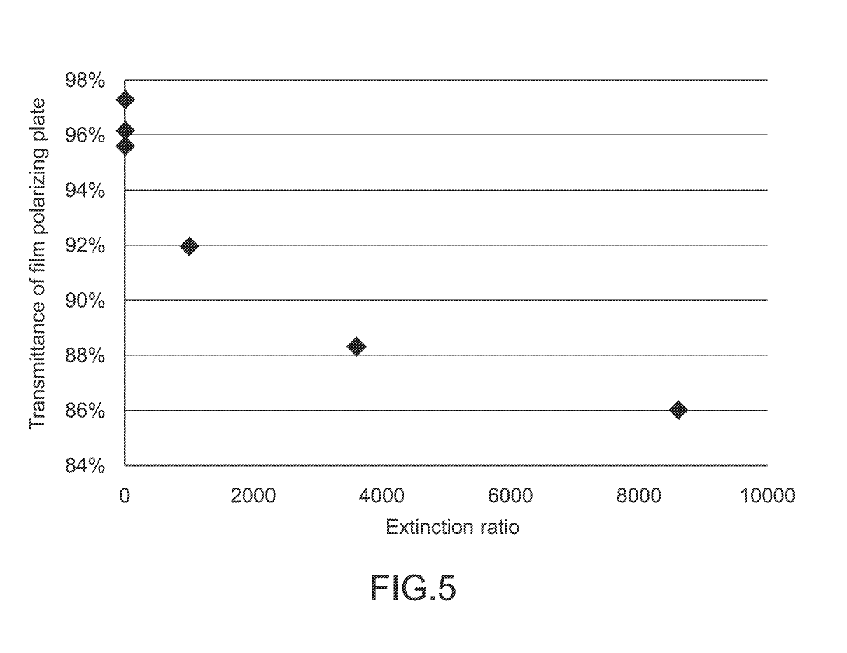

FIG. 4 is a table showing relationships between the extinction ratio of a polarizing plate, the transmittance, and the temperature. FIG. 5 is a graph showing a relationship between the extinction ratio and the transmittance. In order to create the table and the graph, a projector that includes a laser light source and a reflection-type light modulation element and is capable of outputting the illuminance of 15000 lumen is used. Then, the temperature of the polarizing plate for blue laser light having the highest temperature load is measured by a thermocouple. It should be noted that an image signal in a raster format is input.

As shown in FIG. 4 and FIG. 5, the higher the extinction ratio, the lower the transmittance is. The generation of heat due to light absorption increases the temperature. In the image display apparatus 500 according to the embodiment of the present disclosure, a polarizing plate having an extinction ratio of equal to or less than 50:1 is used as the first and second polarizing plate 106 (206) and 107 (207). Moreover, as described above, a polarizing plate having an extinction ratio of equal to or less than 10:1 is used in this embodiment. With a polarizing pate having an extinction ratio within the range, it is possible to apply the modulated light and the combined light to a screen at a high transmittance and to project an image with a high luminance. Further, because the temperatures of the first and second polarizing plates 106 (206) and 107 (207) are suppressed to be low, it is possible to prevent the polarizing characteristics from being deteriorated due to heat, for example. For example, it is recommended that in general, a film polarizing plate made of polycarbonate is used at a temperature below 80° C. In the embodiment of the present disclosure, it is possible to use the film polarizing plate made of polycarbonate appropriately within the range.

In the case where the reflection-type light modulation element 102 (202) is used, the polarizing element 103 (203) being a polarizing beam splitter reflects the unnecessary component light of the modulated light. Therefore, the first and second polarizing plates 106 (206) and 107 (207) play roles in absorbing the unnecessary component light leaked from the polarizing element 103 (203) and cut the light. Therefore, an excessive load is applied to the first and second polarizing plates 106 (206) and 107 (207) less often than the case where a transmission-type light modulation element is used. In a projector for cinema that uses a laser light source, however, there is a need to take into account the temperature rise of the first and second polarizing plates 106 (206) and 107 (207) because the light source unit outputs laser light with high luminance. In this embodiment, by using a polarizing plate having an extinction ratio of equal to or less than 50:1, it is possible to display an image with high precision. In particular, in the case where two display apparatuses are used to display a right eye image and a left eye image as in this embodiment, it is possible to sufficiently prevent crosstalk from occurring.

In the case where a projection lens that projects a right eye image and a projection lens that project a left eye image are separately provided, a polarizing plate can be disposed on an emission side of each projection lens appropriately. On the other hand, in the case where right and left images are combined and the combined image is projected by one projection lens, it is difficult to dispose a polarizing plate on an emission side of the projection lens. This is because the right and left images have different polarizing directions. In this case, by providing the first and second polarizing plates 106 (206) and 107 (207) as in this embodiment, it is possible to display a color image with sufficiently reduced crosstalk and with high precision. Moreover, because the right and left images can be projected by one projection lens, it has advantages in size reduction and reduction in weight of the apparatus.

### Another Embodiment

The present disclosure is not limited to the above-mentioned embodiment and various modifications can be made without departing from the gist of the present disclosure.

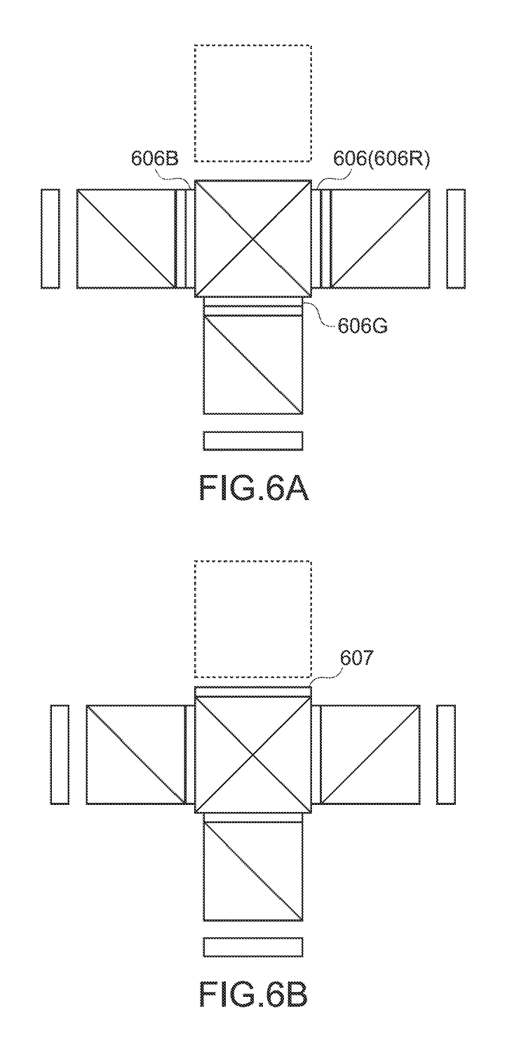

FIGS. 6A-6B are schematic diagrams showing arrangement examples of the first and second polarizing plates. In the above-mentioned embodiment, the three first polarizing plates for the modulated light of the colors and the second polarizing plate for the combined light are arranged, thereby making it possible to display a color image with high precision.

On the other hand, as shown in FIG. 6A, the second polarizing plate does not have to be disposed and only three first polarizing plates 606 (606R, 606G, and 606B) may be disposed. On the contrary, as shown in FIG. 6B, the three first polarizing plates do not have to be disposed, and only a second polarizing plate 607 may be disposed. Because only any one of the three first polarizing plates and the second polarizing plate is disposed, it is possible to reduce the number of components and to reduce component cost. Moreover, only any one or two of the three first polarizing plates 606 (606R, 606G, and 606B) may be disposed, for example.

In the above description, the first and second image display units are used to display a right eye image and a left eye image for three-dimensional display. Specifically, the light source unit, the at least one reflection-type light modulation element, the optical system, and the at least one polarizing plate are used as a set to display the right eye image and the left eye image.

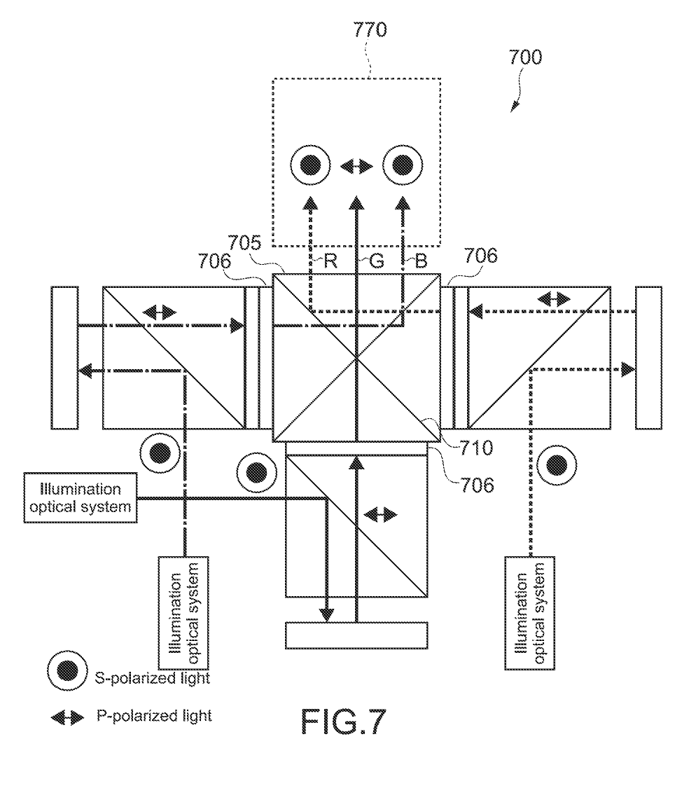

However, as shown in FIG. 7, one image display apparatus 700 may be used alone as the image display apparatus according to this embodiment. In this case, the polarizing directions of the laser light of the RGB colors emitted to a projection optical system 770 may be set to be different to each other. For example, as shown in FIG. 7, the modulated red light R and the blue modulated light B may be emitted as the s-polarized light, and the green modulated light G may be emitted as the p-polarized light. In this case, the second polarizing plate is not disposed, and only a first polarizing plate 706 is disposed. Further, the ½ wavelength plate that rotates the polarizing direction of the green modulated light G is not disposed.

For example, in the case where the red light R and the blue light B of the s-polarized light have favorable reflection properties and the green light G of the p-polarized light has favorable transmission properties on a junction surface 710 of a color combining prism 705, by setting the polarizing directions of the modulated light of the colors to be different to each other as shown in FIG. 7, it is possible to achieve high luminance.

In the second image display unit 200 described above, the wide-band ½ wavelength plate 60 may be disposed between the second polarizing plate 207 and the color combining prism 205. In this case, the direction of the transmission axis of the second polarizing plate 207 is rotated by 90 degrees and is set.

In the above description, three illumination optical systems are provided for the laser light of the RGB colors.

However, the present disclosure is not limited to the configuration. For example, one illumination optical system that emits white laser light may be used. The white laser light may be divided into laser light of the RGB colors, and the laser light of the colors may enter three light modulation elements that modulate red light, green light, and blue light. Alternatively, one illumination optical system and one reflection-type light modulation element may be used to display a color image with the use of a color filter or the like that is capable of switching between colors at high speed. In this case, the combining prism is not used, and a polarizing plate having an extinction ratio of equal to or less than 50:1 is disposed behind the polarizing element, thereby making it possible to increase the degree of polarization of modulated light.

Moreover, it is also possible to provide a ¼ wavelength plate to a light emitting part of the image combing unit that combines a right eye image and a left eye image in such a way that the orientation is 45 degrees with respect to the p-polarized light surface determined by the image combining unit. By providing the ¼ wavelength plate, it is possible to change the polarization state of light emitted from the image combining unit from linear polarization perpendicular to each other to right and left circular polarization. In this case, the ¼ wavelength plate favorably has a wide wavelength band that covers the wavelength range of light to be used. Moreover, glasses including a polarizing filter for right circular polarization combined with a polarizing filter for left circular polarization may be used. By using the glasses having such a configuration, it is possible to prevent crosstalk from occurring. The crosstalk occurs when a user views a screen with tilting his/her head and light that should enter a user's eye partially leaks to the other eye.

In the above, as the image display apparatus, a projector for cinema has been described. However, the present disclosure is not limited thereto, and can be applied also to an image display apparatus used for another usage.

At least two features in the embodiments described above may be combined.

It should be noted that the present disclosure may also take the following configurations.

(1) An image display apparatus, including:

a light source unit including a laser light source;

at least one reflection-type light modulation element configured to modulate light to be incident thereon and reflect the modulated light;

an optical system that includes an optical element configured to cause light from the light source unit to be incident on the at least one reflection-type light modulation element, and to transmit light modulated by the at least one reflection-type light modulation element therethrough, and is configured to emit the modulated light transmitted through the optical element to a projection optical system capable of projecting light; and

at least one polarizing plate that is arranged in the optical system, is configured to control a polarizing direction of the modulated light transmitted through the optical element, and has an extinction ratio of equal to or less than 50:1.

(2) The image display apparatus according to (1), in which

the at least one polarizing plate has an extinction ratio of equal to or less than 10:1.

(3) The image display apparatus according to (1) or (2), in which

the at least one reflection-type light modulation element includes three reflection-type light modulation elements that modulate red light, green light, and blue light,

the optical element is arranged as three optical elements configured to cause the light of the colors to be incident on the three reflection-type light modulation elements, and to transmit modulated red light, modulated green light, and modulated blue light therethrough,

the optical system includes a combining element configured to combine the modulated light of the colors transmitted through the three optical elements and to emit the combined light to the projection optical system, and

the at least one polarizing plate includes at least one of: three polarizing plates for the modulated light of the colors arranged between the three optical elements and the combining element; and a polarizing plate for the combined light emitted from the combining element.

(4) The image display apparatus according to (3), in which

the at least one polarizing plate includes the three polarizing plates for the modulated light of the colors and the polarizing plate for the combined light.

(5) The image display apparatus according to (3) or (4), in which

the three polarizing plates each include a narrow-band polarizing plate having a respective wavelength band of the light of the colors, and

the polarizing plate for the combined light includes a wide-band polarizing plate having a visible wavelength band of the combined light.

(6) The image display apparatus according to any one of (1) to (5), in which

the light source unit, the at least one reflection-type light modulation element, the optical system, and the at least one polarizing plate are used as a set to display a right eye image and a left eye image for three-dimensional display.

(7) The image display apparatus according to (6), in which

the right eye image is displayed by light having a first polarizing direction, and the left eye image is displayed by light having a second polarizing direction perpendicular to the first polarizing direction.

It should be understood by those skilled in the art that various modifications, combinations, sub-combinations and alterations may occur depending on design requirements and other factors insofar as they are within the scope of the appended claims or the equivalents thereof.

What is claimed is:

1. An image display apparatus, comprising:
a light source unit including a laser light source;
at least one reflection-type light modulation element configured to modulate light to be incident thereon and reflect the modulated light;
an optical system that includes an optical element configured to cause light from the light source unit to be incident on the at least one reflection-type light modulation element, and to transmit light modulated by the at least one reflection-type light modulation element therethrough, and is configured to emit the modulated light transmitted through the optical element to a projection optical system capable of projecting light; and
at least one polarizing plate that is arranged in the optical system, is configured to control a polarizing direction of the modulated light transmitted through the optical element, and has an extinction ratio of equal to or less than 50:1.

2. The image display apparatus according to claim 1, wherein
the at least one polarizing plate has an extinction ratio of equal to or less than 10:1.

3. The image display apparatus according to claim 1, wherein
the at least one reflection-type light modulation element includes three reflection-type light modulation elements that modulate red light, green light, and blue light,
the optical element is arranged as three optical elements configured to cause the light of the colors to be incident on the three reflection-type light modulation elements, and to transmit modulated red light, modulated green light, and modulated blue light therethrough,
the optical system includes a combining element configured to combine the modulated light of the colors transmitted through the three optical elements and to emit the combined light to the projection optical system, and
the at least one polarizing plate includes: at least one of three polarizing plates for the modulated light of the colors arranged between the three optical elements and the combining element; and a polarizing plate for the combined light emitted from the combining element.

4. The image display apparatus according to claim 3, wherein
the at least one polarizing plate includes the three polarizing plates for the modulated light of the colors and the polarizing plate for the combined light.

5. The image display apparatus according to claim 3, wherein
the three polarizing plates each include a narrow-band polarizing plate having a respective wavelength band of the light of the colors, and
the polarizing plate for the combined light includes a wide-band polarizing plate having a visible wavelength band of the combined light.

6. The image display apparatus according to claim 1, wherein
the light source unit, the at least one reflection-type light modulation element, the optical system, and the at least one polarizing plate are used as a set to display a right eye image and a left eye image for three-dimensional display.

7. The image display apparatus according to claim 6, wherein
the right eye image is displayed by light having a first polarizing direction, and the left eye image is displayed by light having a second polarizing direction perpendicular to the first polarizing direction.

8. An image display method, comprising:
emitting light by a light source unit including a laser light source;
causing, by an optical element, light from the light source unit to be incident on a reflection-type light modulation element, and transmitting light modulated by the reflection-type light modulation element through the optical element; and
controlling, by at least one polarizing plate that has an extinction ratio of equal to or less than 50:1, a polarizing direction of the modulated light transmitted through the optical element, and emitting the modulated light to a projection optical system capable of projecting light, to display an image.
